(19) United States
(12) Patent Application Publication
(10) Pub. No.: US 2002/0169686 A1
(43) Pub. Date: Nov. 14, 2002

(54) Methods and systems for using portable devices to provide merchandising information

(75) Inventors: Monte Zweben, San Mateo, CA (US); James D. Norman, San Francisco, CA (US); J. Douglas Donohoe, Evergreen, CO (US); Alexander M. Neth, San Mateo, CA (US)

Correspondence Address: Finnegan, Henderson, Farabow, Garrett & Dunner, L.L.P., 1300 I Street, N.W., Washington, DC, 20005-3315, US

(73) Assignee: Blue Martini Software

(21) Appl. No.: 10/098,041

(22) Filed: Mar. 15, 2002

Related U.S. Application Data
(60) Provisional application No. 60/276,803, filed on Mar. 16, 2001.

(51) Int. Cl. G06F 17/60

(52) U.S. Cl. 705/26; 705/14

(57) ABSTRACT

A system and method that provides real-time product and services information to sales personnel so that they may provide accurate and timely information to consumers and to the consumers directly so that they may service themselves. In one embodiment, the present system includes at least one device interfacing with a plurality of consumer and product databases. When a sales associate receives a request for product information from a consumer, the associate inputs the product information into at least one device. The device communicates with a vendor computer over a wireless interface to search at least one database associated with a merchant to identify information about products and services that satisfies the request and/or identifies up-sell and cross-sell products and services. The vendor computer transmits retrieved information to the device, and sales associate communicates timely and accurate product information to the consumer.

### RELATED APPLICATIONS

This application claims priority from the following U.S. Provisional Application, the disclosure of which, including all appendices, is incorporated by reference in its entirety for all purposes: U.S. Provisional Application Serial No. 60/276,803, to Monte Zweben et al., entitled, “Methods and Systems for Using Devices to Provide Merchandising Information,” filed Mar. 16, 2001.

### DESCRIPTION OF THE INVENTION

1. Field of the Invention

The present invention relates to systems and methods for providing real-time information and, more particularly, to systems and methods for providing targeted product and service information to retail consumers and retail associates.

2. Background of the Invention

Traditional retail businesses employ known methods and systems to provide sales, merchandising and retail information to consumers. When a consumer physically goes to a retail store, he or she will browse in-stock items to determine which items the consumer wishes to purchase. A primary source for a consumer to obtain additional product information is a salesperson. However, the quality of service the consumer receives depends on the particular salesperson providing assistance. In some cases, a salesperson will be sufficiently knowledgeable about relevant products or will be able to quickly find necessary information. Other times, the salesperson may lack specific product knowledge or the ability (whether due to lack of competence or lack of access to information) to find out about the products. When sales personnel are unable to fully satisfy consumer inquires, it creates a problem for the consumer and the retail establishment alike. The retail store may miss a sales opportunity and, if the experience is particularly frustrating, even lose customer goodwill.

Problems with traditional retail sales methods are attributable to a number of factors, including: (1) a lack of experienced sales personnel; (2) a prohibitively large product offering; (3) an inability of sales personnel to access consumer information, including past purchases in real-time; and (4) differences in personal product preferences among salespersons and consumers.

Inexperienced salespeople are not able to provide adequate information because they are either not sufficiently knowledgeable about the products to answer questions from personal knowledge, or do not know how to quickly find the information. For example, in a traditional retail setting, a consumer may walk into a consumer electronics store with the purpose of selecting a new Motion Picture Experts Group Layer 3 (“MP3”) player for a gift. As is often the case, the potential consumer does not have considerable knowledge about MP3 players and therefore must rely on sales personnel to provide sufficient information to make the purchase. Unfortunately, in many situations the available sales personnel know little more than the consumer. In this situation, many potential consumers will leave a store without making a purchase or, with doubts as to whether the right product was purchased.

Even in the case of a retail business with a stable and knowledgeable sales force, some businesses deal in such a vast number of constantly changing products that each salesperson cannot possibly possess in-depth knowledge of each product. Consider the example in which a potential consumer is embarking on a home improvement project. Part of the project is to plant ivy to cover a stone wall. The potential consumer may need to drill fasteners into the stone wall to support the ivy. To do so, he or she will need a drill that is sufficiently powerful to drill a hole in the stone wall. In order to obtain such a tool, the potential consumer may visit a nearby home improvement store. As is often the case, the potential consumer may be overwhelmed with the vast array of product choices. In some retail settings, the only available product information is the price. The potential consumer may have no idea which drill is sufficiently powerful enough to drill through rock or otherwise satisfy his or her requirements. Even if the potential consumer finds a salesperson, the salesperson may not have sufficient product information to answer the consumer's questions.

One option for the potential consumer is to buy the largest or the most expensive item, in the hopes that it will be able to perform the task. Unfortunately, size and price do not always correspond directly to the required product attributes. Therefore, the potential consumer is likely to leave the store without purchasing an item, and the home project is stalled.

Regardless of the stability, knowledge, and good intentions of a group of sales personnel, it is unlikely that they (individually or collectively) will remember the items a previous consumer considered, asked about or purchased. Known retail sales methods cannot effectively and inexpensively record observations of past visits and then recall the data to assist the sales agent when providing product information to repeat consumers. A salesperson working in a shoe store who is familiar with a consumer may remember the shoe size and the details of some of the other items purchased by a consumer, but that salesperson may not always be available.

Sales personnel have tastes as varied as the consumers that come to shop in their stores. When sales personnel have tastes that differ from prospective consumers, they may have difficulty providing the right kind of assistance. Take the case in which a consumer may have recently decided to update his wardrobe from jeans to business casual. When the consumer comes into a merchant's store, he needs information about available business casual styles so that he can select clothes that match his tastes and that are compatible with the business environment. As is often the case, the salesperson may apply her own taste to the process of helping a potential consumer select clothes, that may not be the most appropriate given the available choices and the consumer's own tastes.

Prior art retail systems also fail to fully consider the consumer's buying history, interests, tastes, etc. when suggesting cross-sell/up-sell products. Take the case when the point of sale (POS) terminal at a grocery store suggests a second product for the consumer to purchase in response to the consumer's purchase of a first related product. In most cases, the product recommendation is based on the similarity between the two products, and not on the consumer's specific interests. In the past, retailers have only provided product recommendations based on the consumer's specific buying history, interests, tastes, etc., after the consumer has left the store (e.g., via the mail). Therefore it is clear that there are problems with known retail systems due to the fact that prior art systems and methods are unable to provide adequate product information to sales people and potential consumers.

In view of the shortcomings of currently available sales and marketing assistance, it is desirable to provide a system and method that provides real-time information to sales personnel so that they may in turn provide product information to consumers.

### SUMMARY OF THE INVENTION

Systems and methods consistent with the present invention satisfy the above-described need by providing real-time product and services information, both to sales personnel so that they may in turn provide accurate and timely information to customers, and to customers directly so they can better serve themselves. In one embodiment, the present system comprises at least one device interfacing with at least one consumer database and at least one product database. The system is capable of both “pulling” information—i.e., retrieving and transmitting information in response to a specific request—and “pushing” information—i.e., transmitting information, such as a reminder of an upcoming sale, based not on a specific request, but rather on some other prompt. When a sales associate receives a request for product information from a consumer, the associate inputs the request into at least one device. (Alternatively, the consumer seeking information can input the request into the device himself, using self-service.) The device communicates with a vendor computer to search at least one database associated with a merchant to identify product information that satisfies the request. The vendor computer transmits formatted search results to the device, and the sales associate communicates timely and accurate product information to the consumer (or the consumer himself receives the information directly from the device). The device may also push information like upcoming sale days, clearance items, cross-sells, up-sells, which may or may not be based on automatically or manually generated rules etc. to the sales associate for immediate communication to the consumer.

Additional benefits of the invention will be set forth in part in the description which follows, and in part will be obvious from the description, or may be learned by practice of the invention. The benefits of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present invention and together with the description, serve to explain the principles of the invention. In the drawings,

FIG. 1 is a block diagram depicting an illustrative system in which the present invention may be practiced;

FIG. 2 is block diagram depicting components of a vendor computer and an Internet Service Provider in accordance with one embodiment of the present invention;

FIG. 3 is a block diagram depicting the contents of several databases that may be implemented in accordance with one embodiment of the present invention;

FIG. 4 is a flow diagram a method for providing merchandising information in accordance with one embodiment of the present invention;

FIG. 5 is a flow diagram of a method for receiving product search criteria in accordance with one embodiment of the present invention; and

FIG. 6 is a flow diagram of a method for searching product and consumer databases and returning results to users of a device.

### DETAILED DESCRIPTION

In the following detailed description of a first embodiment, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

Turning first to the nomenclature of the specification, the detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures residing in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require logical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc. which are often associated with manual operations performed by a human operator. It must be understood that no such involvement of a human operator is necessary or even desirable in the present invention. The operations described herein are machine operations performed in conjunction with a human operator or user who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, workstations, or personal computers are connected via communication links of various types. In a client server arrangement, programs and data, many in the form of objects, are made available by various members of the system.

Referring now to the drawings, in which like numerals represent like elements throughout the several figures, the present invention will be described.

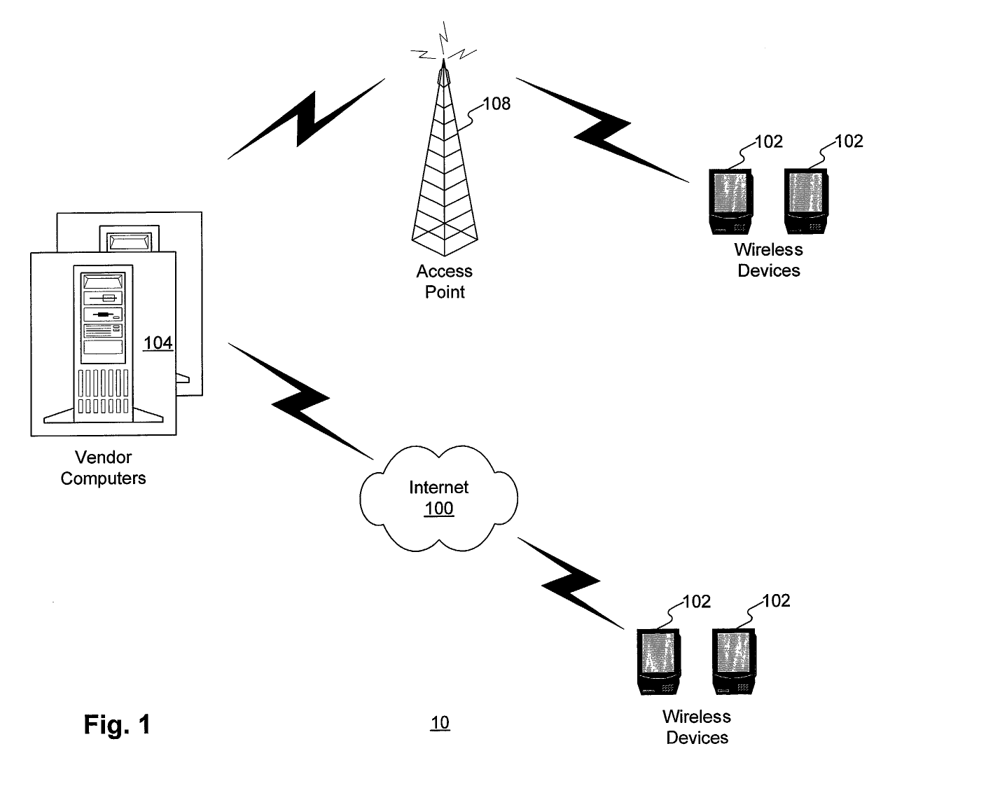

FIG. 1 depicts a representative network environment 10 in which the system and method for is a block diagram illustrating an exemplary system in which the system and method for providing targeted product and service information via a portable networking device may be practiced. As shown in FIG. 1, environment 10 is comprised of a public packet switched network 100, that interconnects plurality of devices 102 with at least one vendor computer 104. Network 100 can be any network topology commonly known by those of ordinary skill in the art, such as Ethernet, a LAN, WAN, ATM network, or Internet. Network 100 may be implemented using any one or a combination of public packet switched network topologies, such as IEEE 802.3 Ethernet, IEEE 802.5 Token Ring, ITU X.25, or serial (SLIP) protocols, for example. Device 102, as further shown in FIG. 1, may interface with a vendor computer 104 via network 100, or directly via an access point 108 over a wire line or wireless interface.

Device 102 may be web-enabled wireless telephones such as for example cellular CDMA, TDMA, or GSM telephones that support the Wireless Access Protocol (“WAP”) or i-Mode data access protocols for displaying web application information. In one embodiment, device 102 includes a bar-code scanner that is used to scan product bar codes so that product information can readily be readily obtained for a specific product. Alternatively, devices 102 may be wireless Internet-connected personal digital assistants (“PDA”), such as, for example, the Palm VIlx from Palm™ Inc. Devices 102 may also be devices such as personal computers that access a network via a protocol such as the Bluetooth protocol. Devices 102 may also be the ruggedized PalmOS-compatible devices available from Symbol, Inc., having a Universal Product Code (“UPC”) scanner and a Radio Frequency (“RF”) transceiver that supports the IEEE 802.11 standard.

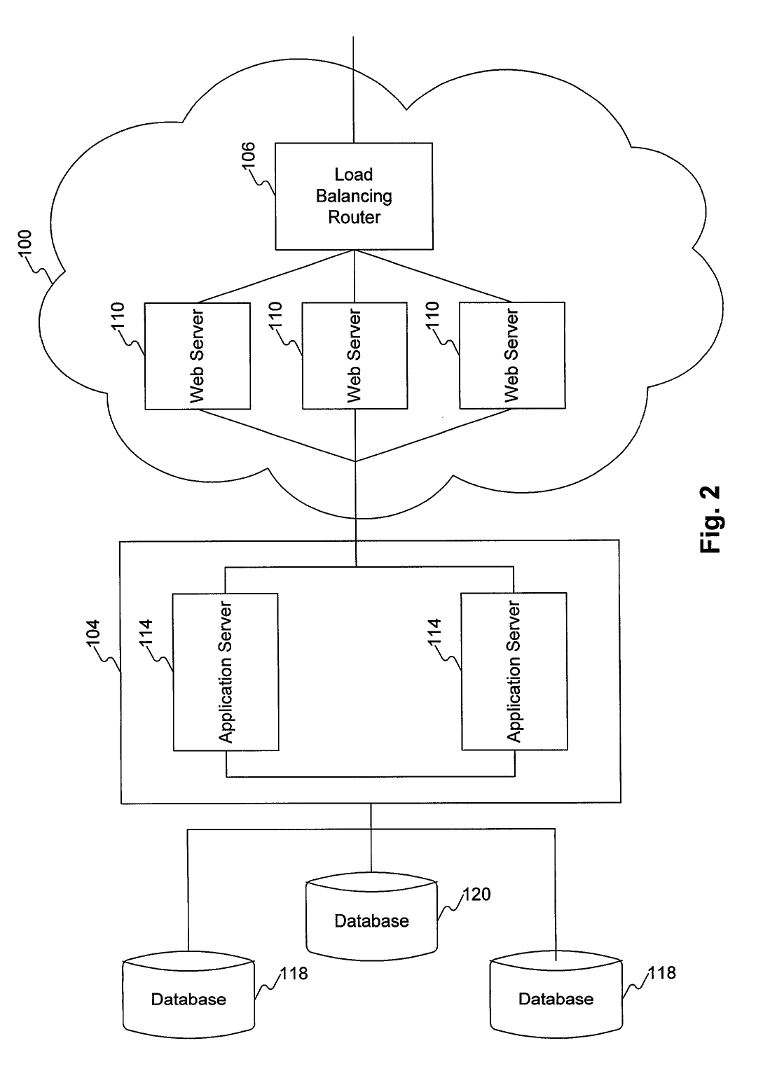

Referring to FIG. 2, there is depicted a vendor computer 104 in accordance with one embodiment of the present invention. As shown, vendor computer 104 is comprised of at least one application server 114 and a plurality of databases (118, 120 and 122). In one embodiment, application servers 114 and 116 are Weblogic™ application servers that are used in connection with Java Server Pages (“JSP”) or Active Server Pages (“ASP”). It will be appreciated, however, that the principles that underlie the invention can be implemented with other types of computer software technologies as well. Application server 114 provides the business logic interface to data stored in databases 118, 120 and 122. When devices 102 access application servers 114 directly, bypassing network 100, application server 114 also provides a presentation interface to the information stored in databases 118, 120, and 122. As shown, vendor computer 104 maintains a product database 118 that comprises available product or service offerings. Vendor computer 104 also maintains a consumer database 120 that comprises consumer identifications. Some embodiments of the present invention will incorporate the all, product database 118 and consumer database 120 on the same machine, while other embodiments separate the product database and the consumer database.

FIG. 2 also depicts a more detailed diagram of network 100 in accordance with one embodiment of the present invention. As shown, network 100 is comprised of a load balancing router and a plurality of web servers 110. Load balancing router 106 is optionally used in some embodiments of the present invention to direct Internet network traffic from devices 102 and other computers that may be accessing web servers 110 via network 100. Load balancing router 106 may be a product such as commercially available load balancing routers that are available from Cisco™ Systems, Inc. Web servers 110 may be any one of a number of well-known computer servers for routing user requests to the proper destination.

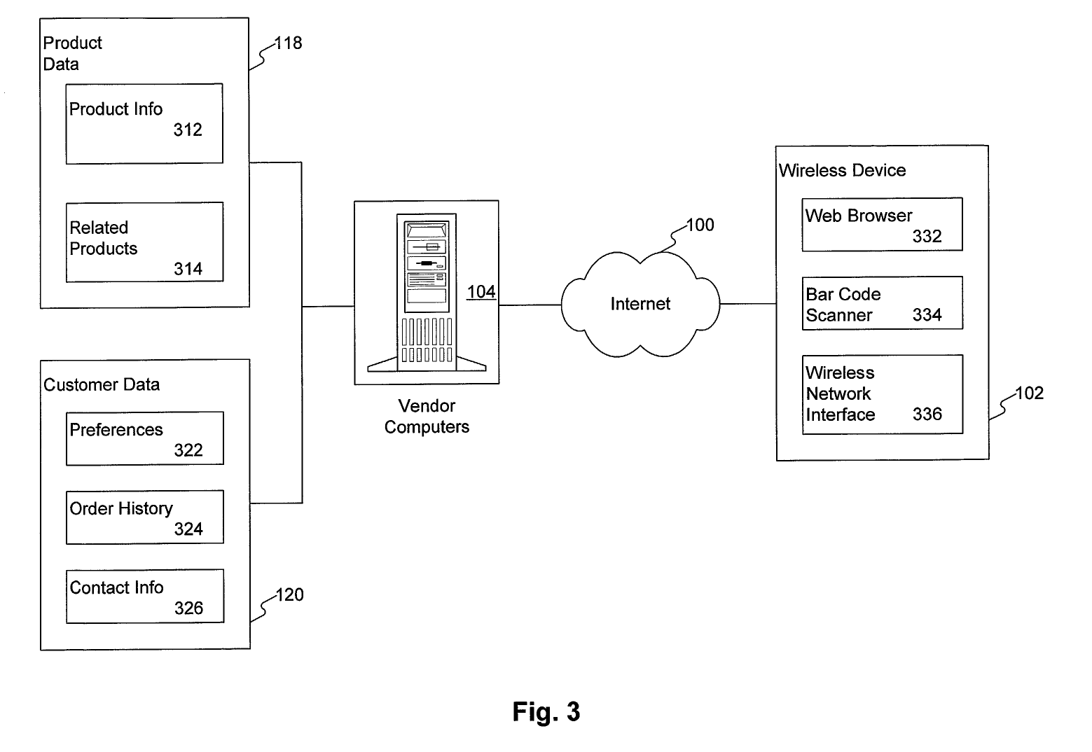

Referring now to FIG. 3, there is shown a more detailed representation of the data stored in product database 118, consumer database 120, and device 102. As shown in FIG. D, product database 118 includes product information 312 and related product information 314. Consumer database 120 includes preferences 322, order history 324 and contact information 326. The data stored on device 102 includes a web browser 332, scanner interface software 334, and a wireless network interface 336.

In one embodiment, product database 118 may include all information (e.g., specifications, images, and descriptions) of each product sold by the organization. It may also include supplementary information a retailer could use to assist sales personnel. For example, an outdoor equipment store might have content that describes what to look for in a sleeping bag, care instructions, or where to go to use the equipment. Product database 118 may further include personalization rules that allow merchandisers to enter more specific information on product suggestions. For example, a merchandiser may determine that teenage boys prefer one style of MP3 player, while teenage girls prefer another style. Personalization allows the merchandiser to enter these rules into product database 118 so that a sales associate may specify general characteristics about the purchaser/gift recipient and then quickly recommend the best product for the situation. Product database 118 is used in connection with the present invention to provide a source of up-sell and cross-sell product information. Up-sell information corresponds to more advanced or more feature-rich (and therefore usually more expensive) products that satisfy the same general purpose as products that satisfy a request made by a potential consumer. Cross-sell information corresponds to information related to additional products that are commonly used in connection with a requested product. Cross-sell and up-sell information may come from a variety of sources including market research, consumer surveys and other investigative techniques.

Consumers and sales people may view a product and click to select other items that may be cross-sold or up-sold with a particular item. For example, a user may view details about a computer product and then select a speaker set that was displayed for the purpose of cross-selling. Additionally, merchandisers may augment cross-sell data by providing rules more specific to a consumer in a particular situation. For example, if a consumer from California selects a jacket, rules may specify that the system should offer her a sun-hat as a cross-sell. If the consumer is from Montana and it is winter, the rule may specify offering a warm fleece hat. Additionally, analytics may be used to find a correlation between buying patterns of particular consumers. Based on a sales model, products are suggested that historically have sold well together. For example, analytics may show that customers who buy a particular DVD player are also likely to favor a particular digital camera.

Consumer data 220 is used in connection with the present invention to provide order history information, gift registry contents, contact information, observed behaviors, consumer preferences to assist sales personnel when satisfying consumer questions, and even clickstream data from Web interactions. Consumer preference data 322 may include demographic data (e.g., name, address, sex, age of a consumer), data describing the nature and peculiarities of a consumer's business (e.g., annual sales, geographic coverage, size), or any other information which might be important in assessing a consumer's affinity for a particular product. Order history 324 may include a listing of all products and services the consumer has ever inquired about, ordered, purchased, returned, etc. Contact information 326 may include the consumer's mailing address, email address, telephone numbers, etc.

In one embodiment consistent with the present invention, a consumer uses device 124 directly to obtain product information 312 in a store. Device 124 may be provided by the retail store for the purpose of providing product information 312 to consumers. In addition to providing product information 312 to a consumer such as the features of a particular product, information on related products 314 (“cross-sell” information) may also be provided. In this embodiment, more advanced products may be offered as alternatives, and “up-sell” information may be provided. Further, a consumer may provide identification information to the wireless terminal, for example, by swiping a loyalty card, providing biometric information, providing a user name and password, or inserting a smart card. Once a consumer has provided consumer information, the consumer may access information related to past purchases, including, for example, clothing sizes or brands with which a consumer was particularly satisfied. A consumer may also provide information related to gift registries, both registering him or herself in a registry and accessing another person's gift registry in order to purchase items on the registry and indicate that particular items had already been purchased.

In a second embodiment, a salesperson may use device 124 to obtain product data 118 and optionally consumer data 120 in order to cross-sell and up sell a consumer in the sales environment. In another embodiment, device 124 may autonomously retrieve sale and product information from vendor computer 104, and then display the information on a display for communication to a consumer by a sales associate. For example, vendor computer 104 or device 124 may determine that the consumer is in the market for a new suit. Once this determination is made, upcoming sale dates for suits may then be retrieved from product database 118 and then displayed for subsequent communication to the consumer.

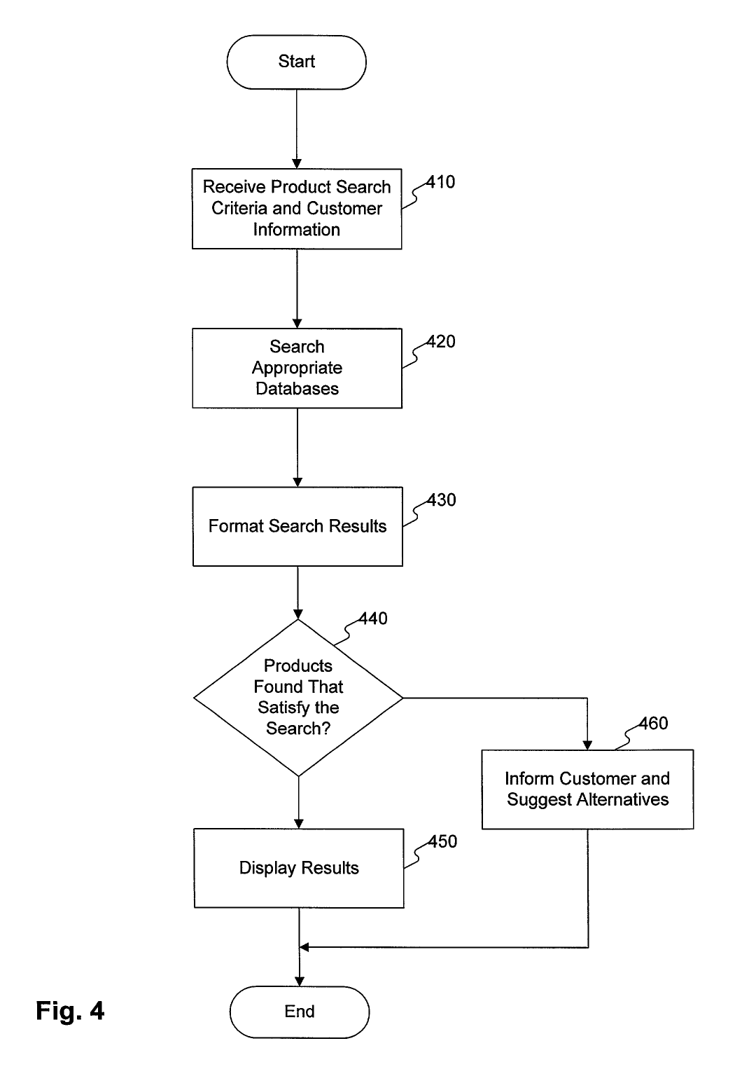

Referring to FIG. 4, there is shown a flow diagram of a method for providing merchandising information consistent with the present invention. First, product search criteria and consumer information is received (step 410). Processing then flows to step 420 where product and consumer databases are searched for information relevant to the search criteria. Next, search results are formatted in a manner consistent with the search results and with system configuration (step 430). If the search results indicate that the requested product is not in stock (step 440), processing flows to step 460 where the user is informed of cross-sell and up-sell items which satisfy his/her request. If the search results indicate that the requested product is in stock (step 440), processing flows to step 450 where search results are displayed on device, including any up-sell and cross-sell information determined from searching product database 118 and consumer database 220.

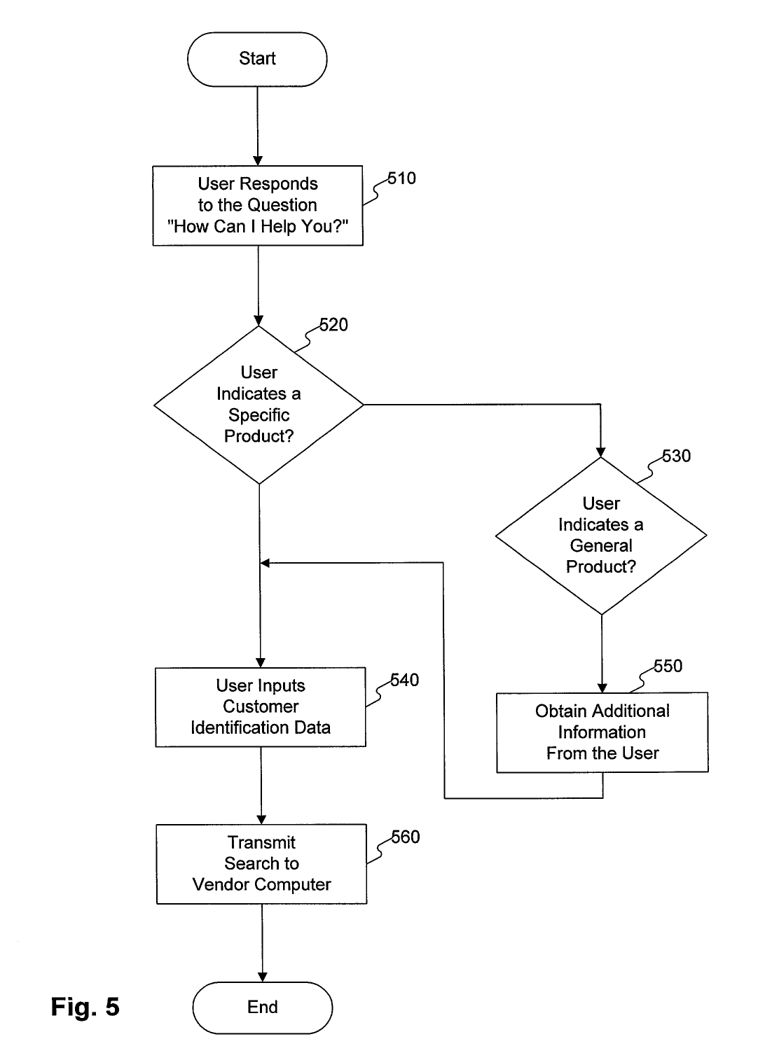

Referring now to FIG. 5, there is shown a more detailed flowchart depicting the steps performed by the present device when it receives product search criteria and consumer information as described in step 410 (FIG. 4). As shown in FIG. 5, processing begins in step 510 when a user (sales associate or consumer) inputs a response to a question displayed on device 124. The user may respond by indicating a specific product he/she would like to purchase (e.g., Giorgio Armani neckties) (step 520) or by indicating a general product (e.g., MP3 players) he/she would like to purchase (step 530). If the user inputs specific product information, processing flows to step 540 where the user then inputs consumer identification information. If the user inputs general product information, processing flows to step 550 where the present invention may request additional information about the consumer (e.g., desired price range, desired product features, dimensions, etc.) before identifying a specific product. One embodiment of the present invention may delay identifying a specific product until the consumer information has been inputted so that previous consumer purchases may be used to assist the identification of a specific product.

Once the necessary information has been obtained, processing flows to step 540 and consumer identification information is obtained. The product identifier information (specific and general), consumer identification information, and any other additional information may be inputted by bar code scanner 334, keyboard, or any other input device. Once the consumer identification information has been received, processing flows to step 560 where the present invention transmits the search information to vendor computer 104. When vendor computer 104 receives the search information, it searches product database 118 and consumer database 220 to determine whether the specific product, cross sell of the product, or up-sell of the product are currently available in the store's inventory.

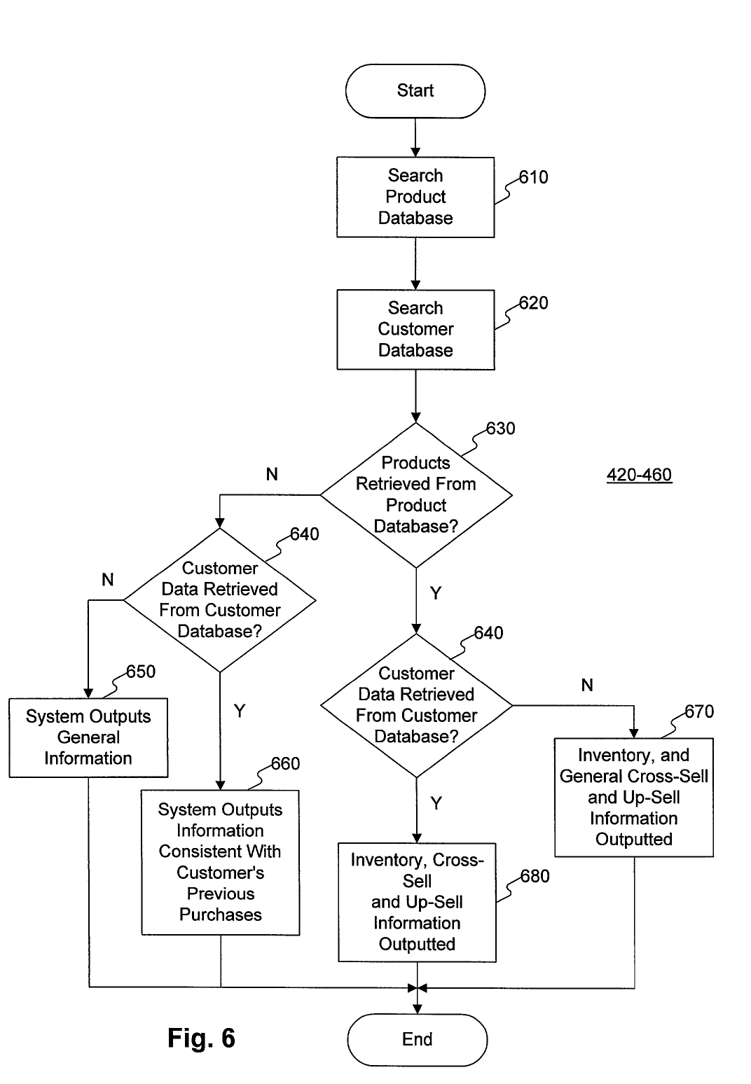

Referring to FIG. 6, there is shown a more detailed flow diagram depicting the steps performed by the present invention when it formats and displays search results as described in steps 420-460 (FIG. 4). Processing begins in step 610 when the present system searches product database 118 for the inputted product by either searching for the specifically inputted product or by converting an inputted general product into a specific product. In operation, general product inquiries are converted into specific product inquiries when the user responds to the questions posed him/her by device 124. For example, a general search for neckties may be more clearly focused when the user responds to questions pertaining to cost and style. When the product search is completed, processing flows to step 620 where the system then retrieves any consumer information that may be on file for the consumer. Processing then flows to step 630 where the system determines whether any products were retrieved from the search performed in step 610. Processing then flows to step 640 where the system determines whether any consumer information was retrieved from the search performed in step 620. If no product information or consumer information was retrieved, processing flows to step 650 where the system outputs general cross sell or up-sell information. If no product information was received, but consumer information was received, processing flows to step 660 where the system outputs cross sell or up-sell information consistent with the consumer's previous purchases. If product information was retrieved, but no consumer information was retrieved from consumer database, processing flows to step 670 where the system outputs inventory information and general cross-sell and upsell information. If product information and consumer information were retrieved, processing flows to step 680 where the system outputs the inventory of the product as well as cross sell and up-sell information specific to the identified product and consumer. For example, if a user inputs Perry Ellis shirts and a recognized consumer identification, and a search of consumer database 220 reveals the fact that the consumer typically buys Giorgio Armani neckties, then the present invention may display a collection of in-stock Perry Ellis shirts and Giorgio Armani neckties to the user of the device. Similarly, the present invention may be used to return higher priced items (up-sell) to the user provided the requested items are not in stock, or when the consumer database 220 indicates that the consumer may be in a higher income bracket and therefore capable of affording the higher-priced item. The processing performed in FIG. 6 reveals the wide range of responses available from device 124 in accordance with the present invention.

If the search results indicate that the requested product is not in stock and there are no up-sell items (or cross-sell items) to satisfy the consumer's request, the user is notified and given an opportunity to order the item for home or in-store delivery, request a rain check, or notification when the product stock is replenished. In an alternate embodiment, device 124 may recommend different merchants who may immediately satisfy the user's request.

The present invention may also be used to assist a sales associate who may not be familiar with the style, cost, type of articles usually purchased by a particular consumer. More specifically, a sales associate may input identification information for a particular consumer and a category of past purchases (e.g., clothes, garden tools, electronics, etc.) From that information, the sales associate will be in a better position for directing the consumer to those articles most likely to appeal to the consumer.

After the sales associate has satisfied the consumer's query, the sales associate may capture notes of the encounter either directly at device 124, or at vendor computer 104 for eventual upload to device 124. In a subsequent meeting with the consumer, a sales associate may use the notes to further assist the next sales associate when dealing with the consumer.

While the previous section describes the operation of the present invention as being performed by a sales associate, it should be understood that operation of the present invention may also be performed by a retail consumer without departing from the spirit and scope of the present invention.

From the foregoing description, it will be appreciated that the present invention provides an efficient system and method for providing real-time merchandising information. The present invention has been described in relation to particular embodiments which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

Although aspects of the present invention are described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the method of the present invention may conveniently be implemented in program modules that are based upon the flow charts in FIGS. 4-6. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems which may be used in practicing the instant invention and therefore no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit and scope. Accordingly, the scope of the present invention is defined by the appended claims rather than the foregoing description.

What is claimed is:

1. A method for providing product, service and order information to a consumer or a sales associate, the method comprising:
inputting the product information into at least one device;
retrieving information from at least one database associated with a merchant to identify product information that satisfies the request; and
transmitting retrieved information to the device.

2. The method of claim 1, wherein the step of inputting the product information further comprises the step of receiving a request for product information from the consumer.

3. The method of claim 1 wherein the step of retrieving information from at least one database further comprises the step of retrieving consumer information from at least one database.

4. The method of claim 1 wherein the step of retrieving information from at least one database further comprises the step of retrieving cross-sell information from at least one database associated with a merchant.

5. The method of claim 1 wherein the step of retrieving information from at least one database further comprises the step of retrieving up-sell information from at least one database associated with a merchant.

6. The method of claim 3 wherein the step of retrieving information from at least one database further comprises retrieving up-sell information based on the retrieved customer information from at least one database associated with a merchant.

7. The method of claim 3, wherein the step of retrieving information from at least one database further comprises filtering the product information based on personalization rules.

8. The method according to claim 1, wherein the step of retrieving information from at least one database further comprises querying the user to obtain more specific information about the consumer's request.

9. The method according to claim 3, wherein the step of retrieving information from at least one database further comprises:
identifying previous consumer purchases; and
using the previous purchases to assist in the identification of product information that satisfies the request.

10. The method of claim 1, wherein the transmitting step further comprises transmitting a message to the user of the device when the requested product is not in stock.

11. The method of claim 10, further including the steps of:
retrieving a consumer address from consumer information; and
transmitting a message to the consumer address when the requested product is in stock.

12. The method of claim 1, further including the step of inputting feedback information associated with the consumer into the device.

13. A method for providing product and order information to a consumer, the method comprising:
retrieving information from at least one database associated with a merchant;
transmitting the information to a computing device; and
communicating the information to a consumer while the consumer is in a merchant's retail store.

14. A computer system for providing product and order information to a consumer, comprising:
a memory having program instructions; and
a processor configured to use the program instructions to input the product information; retrieve information from at least one database associated with a merchant to identify product information that satisfies the request; and display the retrieved information.

15. The computer system of claim 14, wherein the instruction to input the product information further comprises the instruction to retrieve a request for product information from the consumer.

16. The computer system of claim 14 wherein the instruction to retrieve information from at least one database further comprises the instruction to retrieve consumer information from at least one database.

17. The computer system of claim 14 wherein the instruction to retrieve information from at least one database further comprises the instruction to retrieve cross-sell information from at least one database associated with a merchant.

18. The computer system of claim 14 wherein the instruction to retrieve information from at least one database further comprises the instruction to retrieve up-sell information from at least one database associated with a merchant.

19. The computer system of claim 14 wherein the instruction to retrieve information from at least one database further comprises the following instructions retrieve up-sell information based on the retrieved customer information from at least one database associated with a merchant.

20. The computer system of claim 14, wherein the instruction to retrieve information from at least one database further comprises the instruction to filter the product information based on personalization rules.

21. The computer system of claim 14, wherein the instruction to retrieve information from at least one database further comprises the instruction to query the user to obtain more specific information about the consumer's request.

22. The computer system of claim 16, wherein the instruction to retrieve information from at least one database further comprises the following instructions:
identify previous consumer purchases; and
use the previous purchases to assist in the identification of product information that satisfies the request.

23. The computer system of claim 14, wherein the instruction to transmit further comprises transmitting a message to the user of the device when the requested product is not in stock.

24. The computer system of claim 23, further including the instructions to:
retrieve a consumer address from consumer information; and
transmit a message to the consumer address when the requested product is in stock.

25. The computer system of claim 14, further including the instruction to input feedback information associated with the consumer into the device.
